(19) United States
(12) Patent Application Publication
(10) Pub. No.: US 2026/0038293 A1
(43) Pub. Date: Feb. 5, 2026

(54) INFORMATION PROCESSING APPARATUS, INFORMATION PROCESSING METHOD, AND NON-TRANSITORY RECORDING MEDIUM

(71) Applicant: PFU Limited, ISHIKAWA (JP)

(72) Inventors: Masayoshi HAYASHI, ISHIKAWA (JP); Yurika TAKAYAMA, ISHIKAWA (JP)

(21) Appl. No.: 19/282,025

(22) Filed: Jul. 28, 2025

(30) Foreign Application Priority Data
Aug. 1, 2024 (JP) 2024-125802

(51) Int. Cl. G06V 30/418; G06V 30/146

(52) U.S. Cl. CPC G06V 30/418; G06V 30/147

(57) ABSTRACT

An information processing apparatus includes circuitry that extracts one or more candidate areas to be digitized, based on a difference between first image data generated based on an unwritten document and second image data generated based on a written document; executes a character recognition process or a shape recognition process on the second image data to obtain a recognition result; and sets one or more areas to be digitized based on the candidate areas to be digitized and the recognition result.

### CROSS-REFERENCE TO RELATED APPLICATIONS

This patent application is based on and claims priority pursuant to 35 U.S.C. § 119(a) to Japanese Patent Application No. 2024-125802, filed on Aug. 1, 2024, in the Japan Patent Office, the entire disclosure of which is hereby incorporated by reference herein.

### BACKGROUND

The present disclosure relates to an information processing apparatus, an information processing method, and a non-transitory recording medium.

The reading system in the related art generates image data by reading a document such as a form using a reading device such as a scanner, and performs the recognition process on the generated image data to digitize information in the document. The reading system can digitize particular information by performing the recognition process on areas to be digitized from among the areas in the image data, such as an area including a billing amount of a transaction statement.

To digitize the information contained in the areas to be digitized, the user needs to previously set such areas to be digitized. If image data has a large number of areas to be digitized, the operability of the above-described reading system in performing the setting operation by the user tends to be low.

### SUMMARY

The information processing apparatus according to one aspect of the present disclosure includes an information processing apparatus including circuitry that extracts one or more candidate areas to be digitized, based on a difference between first image data generated based on an unwritten document and second image data generated based on a written document, executes a character recognition process or a shape recognition process on the second image data to obtain a recognition result, and sets one or more areas to be digitized based on the candidate areas to be digitized and the recognition result.

The information processing method according to another aspect of the present disclosure includes extracting one or more candidate areas to be digitized, based on a difference between first image data generated based on an unwritten document and second image data generated based on a written document, executing a character recognition process or a shape recognition process on the second image data to obtain a recognition result, and setting one or more areas to be digitized based on the candidate areas to be digitized and the recognition result.

The computer-readable, non-transitory medium storing a computer program according to still another aspect of the present disclosure causes one or more computers to perform an information processing method including extracting one or more candidate areas to be digitized, based on a difference between first image data generated based on an unwritten document and second image data generated based on a written document, executing a character recognition process or a shape recognition process on the second image data to obtain a recognition result, and setting one or more areas to be digitized based on the candidate areas to be digitized and the recognition result.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a reading system that includes an information processing apparatus having an example function configuration;

FIGS. 2A and 2B are diagrams for describing examples of operation using the reading system of FIG. 1;

FIGS. 3A and 3B are diagrams illustrating examples of a process performed by reading systems;

FIGS. 4A-1 and 4A-2 are diagrams illustrating a first example of an unwritten document and a written document;

FIGS. 4B-1 and 4B-2 are diagrams illustrating a second example of an unwritten document and a written document;

FIG. 5 is a diagram illustrating an example of a hardware configuration of an information processing apparatus;

FIG. 6 is a diagram illustrating an example of a functional configuration of an area setting unit of the information processing apparatus of FIG. 1;

FIG. 7 is a diagram illustrating an example of a process performed by a matching unit of the information processing apparatus of FIG. 1;

FIG. 8A is a diagram illustrating a first example of a process performed by a differential image generation unit of the information processing apparatus of FIG. 1;

FIG. 8B is a diagram illustrating a second example of a process performed by the differential image generation unit of the information processing apparatus of FIG. 1;

FIG. 9 is a diagram illustrating an example of a process performed by a character recognition processing unit of the information processing apparatus of FIG. 1;

FIG. 10 is a diagram illustrating an example of a process performed by a shape recognition processing unit of the information processing apparatus of FIG. 1;

FIG. 11 is a first diagram illustrating an example of a process performed by a setting unit of the information processing apparatus of FIG. 1;

FIG. 12 is an example of a first flowchart of processes performed by the setting unit of the information processing apparatus of FIG. 1;

FIG. 13 is a second diagram illustrating an example of the process performed by the setting unit of the information processing apparatus of FIG. 1;

FIG. 14 is an example of a second flowchart of processes performed by the setting unit of the information processing apparatus of FIG. 1;

FIG. 15 is a diagram illustrating an example of a process performed by an area adjusting unit of the information processing apparatus of FIG. 1;

FIG. 16 is a diagram illustrating a first example of a process performed by an adjusting unit of the information processing apparatus of FIG. 1;

FIG. 17 is a diagram illustrating a second example of the process performed by the adjusting unit of the information processing apparatus of FIG. 1;

FIG. 18 is a diagram illustrating a third example of the process performed by the adjusting unit of the information processing apparatus of FIG. 1;

FIG. 19 is an example of a flowchart of processes performed by an area adjusting unit of the information processing apparatus of FIG. 1;

FIG. 20 is an example of a flowchart of an area setting process performed by the reading system of FIG. 1;

FIG. 21 is a diagram illustrating an example of a setting screen displayed in an area setting process; and

FIGS. 22A, 22B, 22C, 22D-1, and 22D-2 are diagrams illustrating a fourth example of the process performed by the adjusting unit of the information processing apparatus of FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments will be described below with reference to the drawings. In this specification and drawings, elements having substantially the same functional configurations are denoted by the same reference numerals, and redundant descriptions thereof are simplified or omitted.

### Overview of Reading System

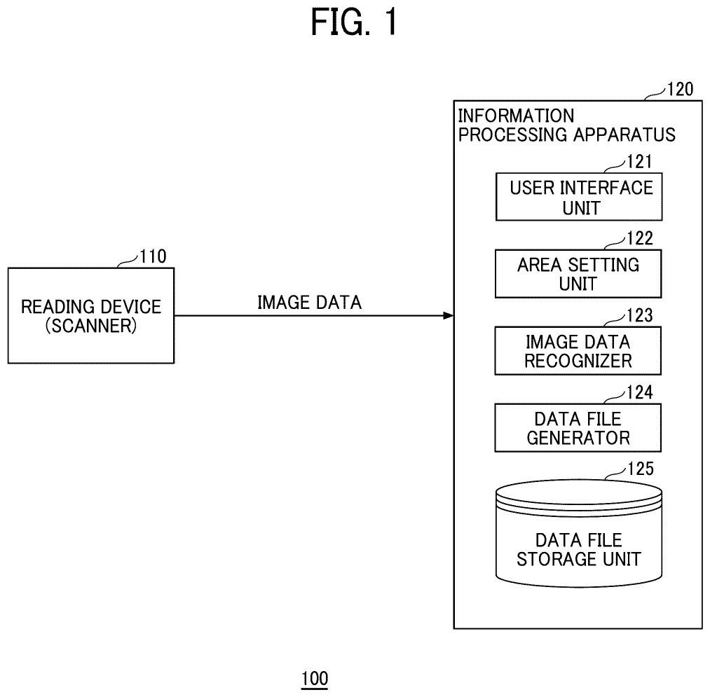

An overview of a reading system including an information processing apparatus is described. FIG. 1 is a diagram illustrating an example of a system configuration of a reading system 100 including an information processing apparatus 120. FIG. 1 also illustrates an example of a functional configuration of the information processing apparatus 120.

As illustrated in FIG. 1, the reading system 100 includes a reading device 110, which is implemented by a scanner, and the information processing apparatus 120. In the reading system 100, the reading device 110 and the information processing apparatus 120 are communicatively connected with each other, for example, via a network.

The reading device 110 reads a document such as a form, and generates image data based on the read document. The reading device 110 transmits the generated image data to the information processing apparatus 120.

The information processing apparatus 120 performs a recognition process on areas to be digitized, each being a preset area of the image data transmitted from the reading device 110, to digitize particular information described in the areas to be digitized into electronic data.

An information processing program is installed in the information processing apparatus 120. With the execution of the information processing program, the information processing apparatus 120 functions as a user interface unit 121, an area setting unit 122, an image data recognizer 123, and a data file generator 124.

The user interface unit 121 provides a user with a user interface, which allows the user to instruct the execution of a series of processes from reading the document to digitizing the information described in the preset areas to be digitized. Examples of the user interface include a screen.

In the setting phase, the area setting unit 122 sets, in the image data transmitted from the reading device 110, the areas to be digitized each written with the information to be digitized. When setting the areas to be digitized, the area setting unit 122 also sets, for example, items indicated by the information described in the areas to be digitized or attributes of the information described in the areas to be digitized.

In the recognition phase, the image data recognizer 123 extracts the areas to be digitized, each having been set by the area setting unit 122 in the setting phase, from the image data transmitted from the reading device 110, and performs the recognition process on the extracted areas.

The data file generator 124 arranges the recognition results (electronic data) obtained through the recognition process performed by the image data recognizer 123 in a predetermined format, to generate a data file. The data file generator 124 stores the generated data file in the data file storage unit 125.

### Example Use of Reading System

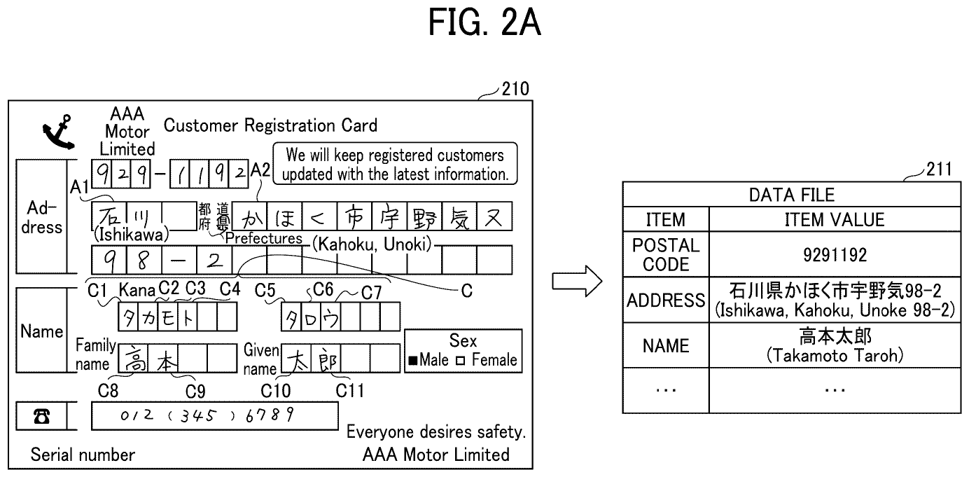

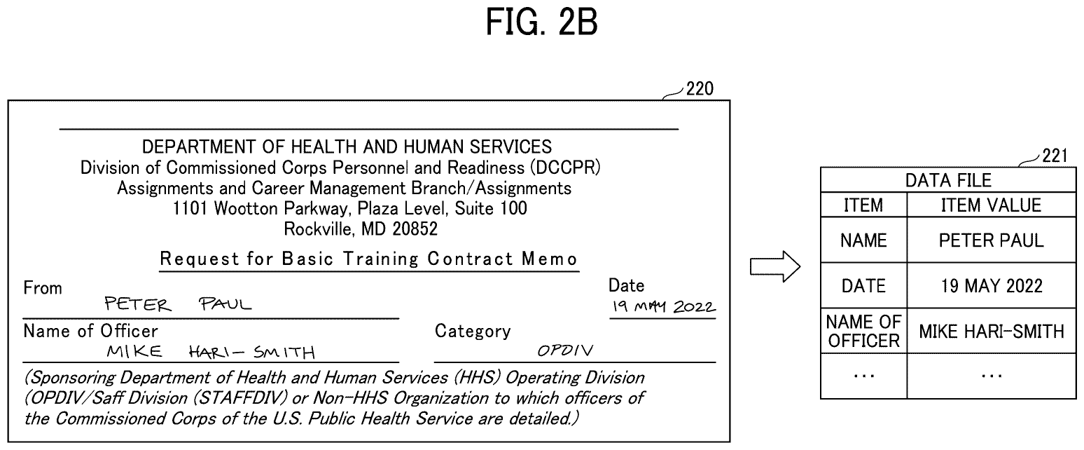

An example operation of using the reading system 100 is described below. FIGS. 2A and 2B are diagrams each for describing an example of operation of using the reading system 100.

FIG. 2A illustrates image data 210, which is an example of image data generated by reading a document with the reading device 110. The image data 210 is an example of image data generated by reading the written document on which a writer has written the postal code, address, name, gender, telephone number, etc., using the reading device 110.

FIG. 2A further illustrates a data file 211, which is generated by extracting, from the image data 210, at least areas that contain the postal code, address, and name, respectively, as the areas to be digitized, and performing the recognition process on each extracted area. The data file 211 includes “items” and “item values”, and the recognition results are arranged in the corresponding fields of the data file 211 according to a preset format.

Similarly, FIG. 2B illustrates image data 220, which is another example of image data generated by reading a document with the reading device 110. The image data 220 is an example of image data generated by reading the written document on which a writer has written the name, date, name of officer, etc., using the reading device 110.

FIG. 2B further illustrates a data file 221, which is generated by extracting, from the image data 220, at least areas that contain the name, date, and name of the officer, respectively, as the areas to be digitized, and performing the recognition process on each extracted area. The data file 221 includes “items” and “item values”, and the recognition results are arranged in the corresponding fields of the data file 221 according to a preset format.

### Process of Reading System

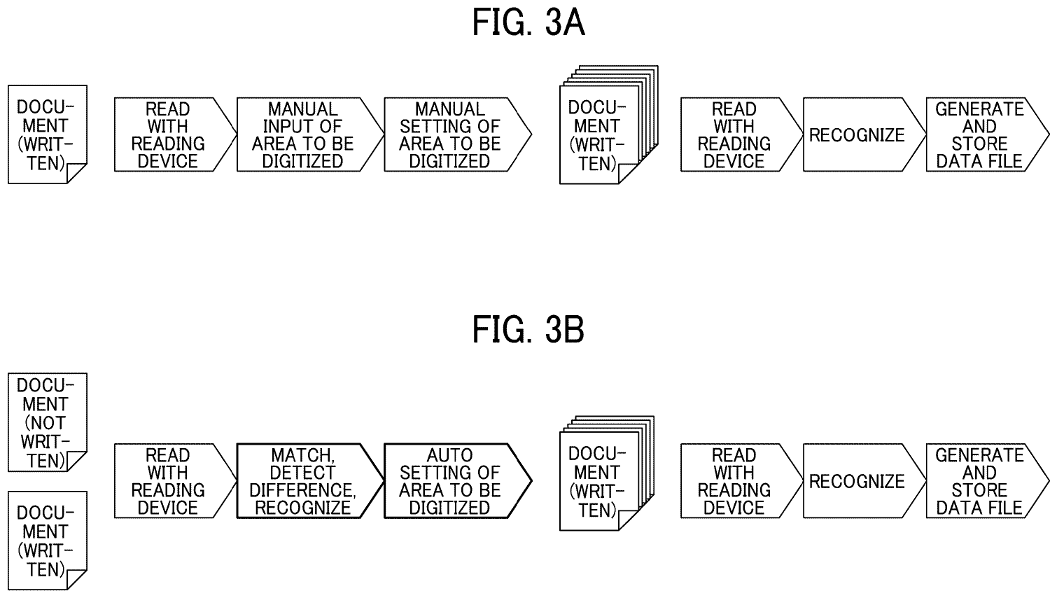

The example of the processes performed by the reading system 100 is described below. In the following, the process of the reading system 100 is described in comparison with a comparative example. FIGS. 3A and 3B are diagrams illustrating examples of the process performed by different reading systems.

Specifically, FIG. 3A illustrates the process performed by the reading system according to the comparative example. As illustrated in FIG. 3A, in the case of the reading system of the comparative example, a written document that has been written by a certain writer is used in the setting phase.

Specifically, a reading device reads the written document to generate image data. The read image data is displayed to the user. The user manually selects one or more areas to be digitized in the displayed image data, which are subject to the recognition process. For example, the user manually draws a circumscribing rectangle that encloses the character information subjected to the recognition process. Specifically, the user manually draws the circumscribing rectangle that encloses all characters subjected to the recognition process. The user further sets each area of the circumscribing rectangle as the area to be digitized.

As illustrated in FIG. 3A, in the case of the reading system of the comparative example, in the recognition phase, all documents having the contents written (“written documents”) by the writer are processed.

Specifically, the reading device reads the written documents in sequence, and generates a plurality of pieces of image data. For each of the plurality of pieces of image data, the recognition process is performed on the areas to be digitized each having been previously set in the setting phase. The recognition results (electronic data) obtained by executing the recognition process on the areas to be digitized are arranged in a predetermined format, and a data file is generated based on the arranged recognition results. The generated data file is stored in a data file storage unit.

FIG. 3B illustrates the process performed by the reading system 100 according to the present embodiment. As illustrated in FIG. 3B, in the setting phase, the reading system 100 uses the unwritten document having no information written by the writer, and the written document having information written by the writer.

Specifically, the reading device 110 reads the unwritten document and the written document, and generates the image data for each of the unwritten document and the written document. The matching process, the difference detection process, and the recognition process are applied to the read image data to extract the areas to be digitized. The extracted areas to be digitized are adjusted as needed, and the adjusted areas to be digitized are automatically set.

As described above, the information processing apparatus 120 automatically sets the areas to be digitized. Accordingly, even when the image data has a large number of areas to be digitized, operability for the user in setting operation is enhanced when compared to the case where the areas to be digitized are manually set by the user.

The process in the recognition phase of FIG. 3B is the same as the process in the recognition phase of FIG. 3A, and the description thereof is omitted.

### Examples of Document

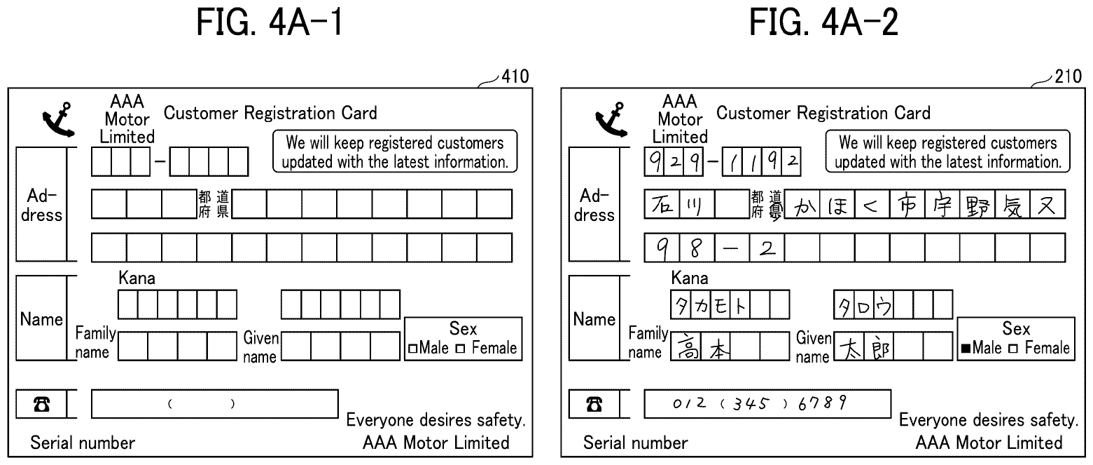

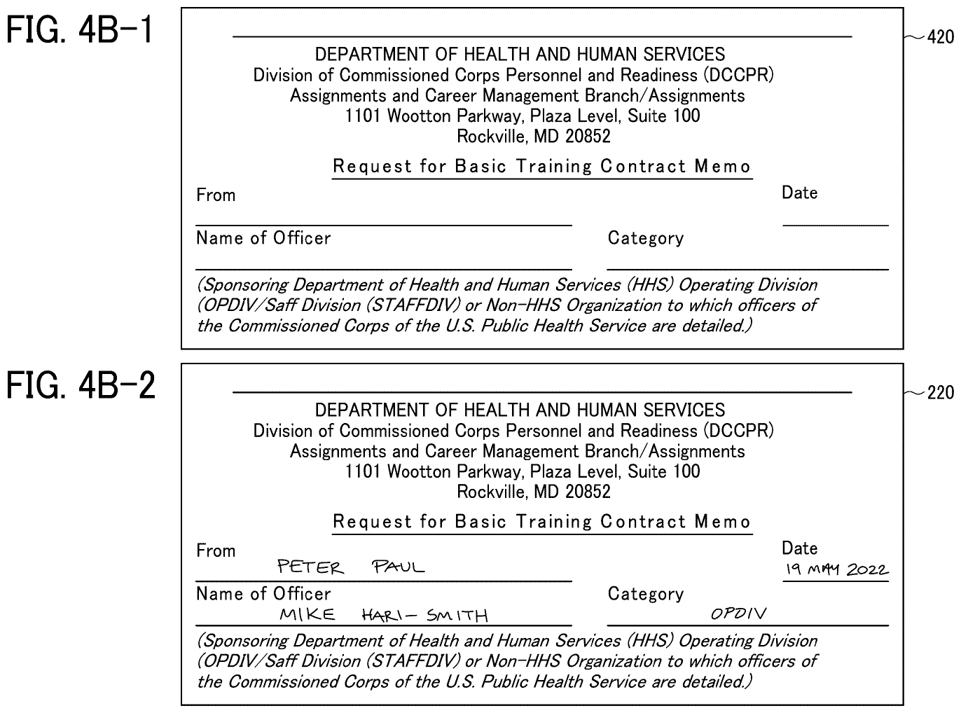

Examples of the unwritten document and the written document used by the reading system 100 in the setting phase are described below. FIGS. 4A-1 and 4A-2 are diagrams illustrating a first example of the unwritten document and the written document. The image data 210 is an example of image data generated by reading the written document with the reading device 110, and is the same as the image data 210 of FIG. 2. The image data 410 is image data, which corresponds to the image data 210, and is an example of image data generated by reading the unwritten document with the reading device 110.

FIGS. 4B-1 and 4B-2 are diagrams illustrating a second example of the unwritten document and the written document. The image data 220 is an example of image data generated by reading the written document with the reading device 110, and is the same as the image data 220 of FIG. 2. The image data 420 is image data, which corresponds to the image data 220, and is an example of image data generated by reading the unwritten document with the reading device 110.

### Hardware Configuration of Information Processing Apparatus

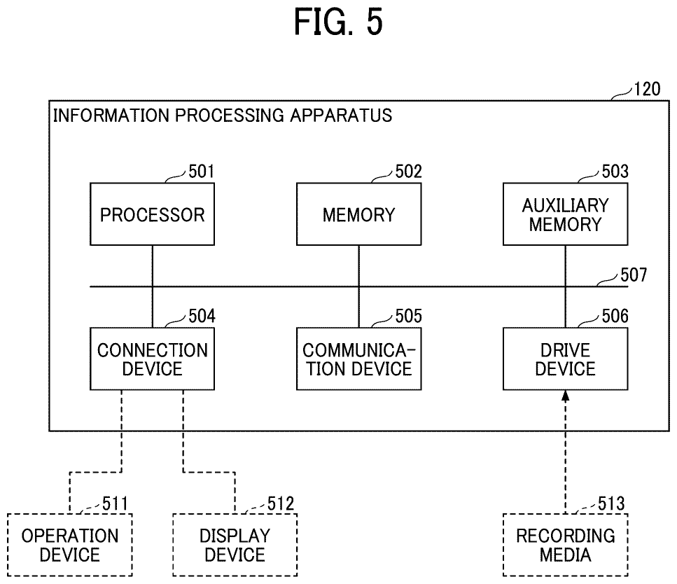

A hardware configuration of the information processing apparatus 120 is described below. FIG. 5 is a diagram illustrating an example of the hardware configuration of the information processing apparatus 120. As illustrated in FIG. 5, the information processing apparatus 120 includes a processor 501, a memory 502, an auxiliary memory 503, a connection device 504, a communication device 505, and a drive device 506. The hardware elements included in the information processing apparatus 120 are connected to each other via a bus 507.

The processor 501 includes various computing devices such as a central processing unit (CPU) and a graphics processing unit (GPU). The processor 501 reads various programs (for example, the information processing program) onto the memory 502, and executes the programs.

The memory 502 includes a main storage device such as a read-only memory (ROM) and a random-access memory (RAM). The processor 501 and the memory 502 together form a so-called computer or a part of the computer. The processor 501 executes various programs read onto the memory 502 to cause the computer to implement various functions.

The auxiliary memory 503 stores various programs and various information used by the processor 501 in executing the various programs.

The connection device 504 connects external devices, such as an operation device 511 and a display device 512, to the information processing apparatus 120. The connection device 504 may be implemented by an input and output interface circuit.

The communication device 505 transmits or receives various types of information between the reading device 110 and the information processing apparatus 120, for example, through a network. The communication device 505 may be implemented by a network interface circuit.

A recording medium 513 is placed into the drive device 506. Examples of the recording medium 513 include a recording medium that records data optically, electrically or magnetically, such as a compact disc-read-only memory (CD-ROM), a flexible disk, and a magneto-optical disc. Other examples of the recording medium 513 include a semiconductor memory that electrically records data such as a ROM or a flash memory.

The various programs to be installed are stored in the auxiliary memory 503, for example, by placing the recording medium 513 having been distributed into the drive device 506, and causing the drive device 506 to read out the various programs recorded on the recording medium 513. Alternatively, the various programs to be installed are stored in the auxiliary memory 503, by downloading the programs from the network via the communication device 505.

### Functional Configuration of Area Setting Unit of Information Processing Apparatus

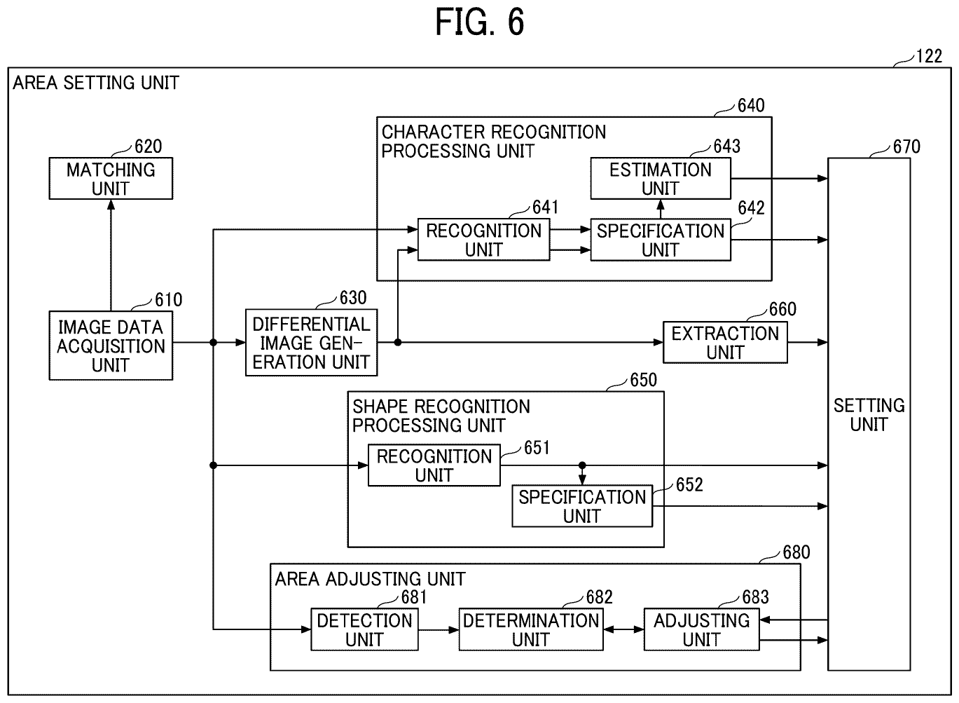

A functional configuration of the area setting unit 122 of the information processing apparatus 120 that operates in the setting phase is described below. FIG. 6 is a diagram illustrating an example of a functional configuration of the area setting unit 122 of the information processing apparatus 120.

As illustrated in FIG. 6, the area setting unit 122 includes an image data acquisition unit 610, a matching unit 620, a differential image generation unit 630, a character recognition processing unit 640, a shape recognition processing unit 650, an extraction unit 660, a setting unit 670, and an area adjusting unit 680.

The image data acquisition unit 610 acquires, from the reading device 110, image data (first image data) generated by reading the unwritten document, and image data (second image data) generated by reading the written document.

The matching unit 620 compares the first image data and the second image data each acquired by the image data acquisition unit 610, and determines whether the unwritten document and the written document each read by the reading device 110 in the setting phase have the same format.

The matching unit 620 may use any desired matching method. For example, the matching unit 620 may perform matching based on the similarity between the feature value extracted from the first image data and the feature value extracted from the second image data. The feature value may be obtained using, for example, the Accelerated KAXE (AKAZE) algorithm or the Oriented FAST and Rotated BRIEF (ORB) algorithm. The similarity in the feature value may be calculated using the k-Nearest Neighbor (KNN) algorithm with L1-norm, or the ε-nearest neighbor algorithm with Hamming distance.

In the above-described embodiment, to increase the matching accuracy, the matching unit 620 finds matches between the first image data and the second image data using edges, frames, lines, and pixel densities, and performs positioning processing of the image data based on the edges of the first image data and the second image data that are associated.

When the matching unit 620 determines that the first image data and the second image data do not have the same format (when the matching fails), the matching unit 620 displays a message indicating that the matching has failed to the user via the user interface unit 121. The area setting process by the area setting unit 122 then ends.

When the matching unit 620 determines that the first image data and the second image data have the same format (when the matching succeeds), the matching unit 620 displays a message indicating that the matching has succeeded to the user via the user interface unit 121. The area setting process by the area setting unit 122 then continues.

The differential image generating unit 630 calculates the difference between the first image data and the second image data each acquired by the image data acquisition unit 610, and generates differential image data. The differential image generating unit 630 notifies the extraction unit 660 and the character recognition processing unit 640 of the generated differential image data.

The character recognition processing unit 640 is a functional unit, which performs the character recognition process on the second image data or the differential image data, and obtains information used for setting the areas to be digitized. The character recognition processing unit 640 further includes a recognition unit 641, a specification unit 642, and an estimation unit 643.

The recognition unit 641 performs the character recognition process on the second image data acquired by the image data acquisition unit 610. When character information is acquired as a result of the character recognition process, the recognition unit 641 notifies the specification unit 642 of the acquired character information.

The recognition unit 641 further performs the character recognition process on the differential image data generated by the differential image generation unit 630. When character information is acquired as a result of the character recognition process, the recognition unit 641 notifies the specification unit 642 of the acquired character information.

The specification unit 642 determines whether the character information, which is acquired as the result of the character recognition process performed on the second image data, has an attribute indicating mark data. The mark data refers to a character string that indicates a mark. Examples of character strings include the following.
[symbol] [symbol] [symbol] [symbol] [symbol] [symbol] ⊙

When the specification unit 642 determines that the attribute of the character information indicates mark data, the specification unit 642 notifies the setting unit 670 of the area of the character information having the attribute of the mark data.

The specification unit 642 determines whether the character information, which is acquired as the result of the character recognition process performed on the differential image data, has an attribute indicating text data. When the specification unit 642 determines that the attribute of the character information does not indicate mark data, the specification unit 642 determines that the attribute of the character information indicates text data, and notifies the estimation unit 643 of the character information having the attribute of the text data.

When the estimation unit 643 is notified by the specification unit 642 that the character information has the attribute of the text data, the estimation unit 643 estimates an item indicated by the character information, and notifies the setting unit 670 of the estimated item. The estimation unit 643 may estimate the item using any desired method. For example, a classifier that identifies an item to be estimated (for example, a name, an address, or other) may be prepared in advance. The character information may be input to the classifier to estimate the item indicated by the character information. The classifier may be implemented by the machine-learned model that has been previously trained using the natural language library such as FastText.

The estimation unit 643 may further estimate the item of the character information classified as “other” by the classifier based on a predetermined notation rule. For example, to estimate whether the item indicated by the character information is a telephone number, the estimation may be made based on the notation rule indicating that the number of digits is 10 and the digits match the existing area code. Alternatively, the estimation may be made based on the notation rule indicating that the number of digits is 11 and the first three digits are either 070, 080, or 090.

In another example, to estimate whether the item indicated by the character information is a postal code, the estimation may be made based on the notation rule indicating that the number of digits is 7 and the digits match the existing postal code.

In another example, to estimate whether the item indicated by the character information is a social security number, the estimation may be made based on the notation rule indicating that the number of digits is 12 and the value calculated from the first 11 digits matches the check digit of the remaining digit. For example, the check digit is “x” in the case of the 12-digit number of “abcdefghijkx”. “x” is calculated with the formula x=11−(6a+5b+4c+3d+2e+7f+6g+5h+4i+3j+2k) mod 11 (if x>=10, then x=0).

The shape recognition processing unit 650 is a functional unit, which performs the geometric shape recognition process on the second image data, and obtains information used for setting the areas to be digitized. The shape recognition processing unit 650 further includes a recognition unit 651 and a specification unit 652.

The recognition unit 651 executes the shape recognition process on the second image data acquired by the image data acquisition unit 610. When the recognition unit 651 acquires code information as a result of executing the shape recognition process, the recognition unit 651 notifies the setting unit 670 of the area of the acquired code information, and also notifies the specification unit 652 of the acquired code information. When the recognition unit 651 acquires image information, which is an image other than the code of the code information as the result of executing the shape recognition process, the recognition unit 651 notifies the setting unit 670 of the area of the acquired image information.

When the specification unit 652 is notified by the recognition unit 651 that the code information is acquired as a result of executing the shape recognition process, the specification unit 652 specifies the type of the code information. In the case where the code information is a barcode, the type of the code information is, for example, UPC-A/EAN/JAN, Code3of9, CODE128/EAN128, or PDF417. In the case where the code information is a QR code, the type of the code information is, for example, model 1, model 2, or micro QR.

The extraction unit 660 extracts one or more candidate areas to be digitized based on the differential image data notified by the differential image generation unit 630, and notifies the setting unit 670 of the extracted candidate areas to be digitized.

The setting unit 670 sets the areas to be digitized based on the candidate areas to be digitized that are notified by the extraction unit 660, and the character recognition result notified by the character recognition processing unit 640 or the shape recognition result notified by the shape recognition processing unit 650.

Specifically, in one example, the setting unit 670 sets the candidate areas to be digitized, which are notified by the extraction unit 660, as the areas to be digitized. The candidate areas to be digitized are extracted based on the differential image data.

Additionally or alternatively, the setting unit 670 sets the area of the character information, which has been notified by the specification unit 642 of the character recognition processing unit 640 and determined to have the attribute of mark data, as the area to be digitized.

Additionally or alternatively, the setting unit 670 sets the area of the code information and the area of the image information, which are notified by the recognition unit 651 of the shape recognition processing unit 650, as the areas to be digitized.

For one or more areas to be digitized, the setting unit 670 further sets the item, which is obtained from the estimation unit 643 of the character recognition processing unit 640, in association with the area to be digitized. The setting unit 670 sets the type of the code information obtained from the specification unit 652 of the shape recognition processing unit 650, in association with the area to be digitized.

When an instruction to adjust is received from the area adjusting unit 680, the setting unit 670 sets the areas to be digitized after adjustment.

When the area adjusting unit 680 detects one or more line segments at a location corresponding to the areas to be digitized that are set by the setting unit 670, the area adjusting unit 680 adjusts the areas to be digitized being set based on the detected line segments. The area adjusting unit 680 transmits the instruction to adjust to the setting unit 670, such that the areas to be digitized after the adjustment are set. The area adjusting unit 680 includes a detection unit 681, a determination unit 682, and an adjusting unit 683.

The detection unit 681 executes the line segment detection process on the second image data acquired by the image data acquisition unit 610 to detect one or more line segments in the second image data. The detection unit 681 may use any desired line segment detection method. For example, the detection unit 681 may detect one or more line segments by performing the Hough transform on the second image data.

The determination unit 682 determines the type of the detected line segments based on the positional relationship between the line segments detected by the detection unit 681 and the set areas to be digitized.

The adjusting unit 683 adjusts the shape of the set areas to be digitized, based on the result of the determination by the determination unit 682. Specifically, when the adjusting unit 683 determines that the detected line segments represent a rectangular frame surrounding the set area to be digitized, the adjusting unit 683 adjusts the shape of the set area to be digitized based on the rectangular frame. Alternatively, when the adjusting unit 683 determines that the detected line segments represent an underline of the set area to be digitized, the adjusting unit 683 adjusts the shape of the set area to be digitized based on the underline. The adjusting unit 683 notifies the setting unit 670 of the areas to be digitized after the adjustment, and transmits the instruction to adjust to the setting unit 670, so that the areas to be digitized after the adjustment are set.

### Examples of Processes by Each Unit of Area Setting Unit

Examples of processes, performed by the area setting unit 122, are described below.

In the following examples, the processes are performed by the matching unit 620, the differential image generation unit 630, the character recognition processing unit 640, the shape recognition processing unit 650, the extraction unit 660, the setting unit 670, and the area adjusting unit 680.

### (1) Example of Process by Matching Unit

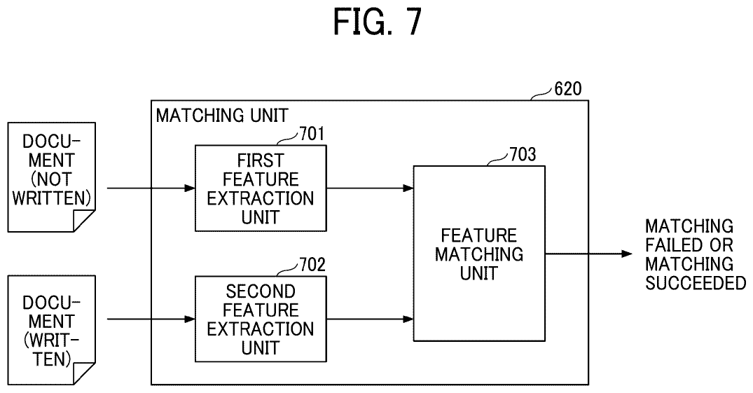

First, an example of a process performed by the matching unit 620 is described. FIG. 7 is a diagram illustrating the example of the process performed by the matching unit 620. As illustrated in FIG. 7, the matching unit 620 includes a first feature extraction unit 701, a second feature extraction unit 702, and a feature matching unit 703.

The first feature extraction unit 701 extracts the feature value from the first image data acquired by the image data acquisition unit 610, and notifies the feature matching unit 703 of the extracted feature value. The first image data is image data generated by reading the unwritten document with the reading device 110.

The second feature extraction unit 702 extracts feature value from the second image data acquired by the image data acquisition unit 610, and notifies the feature matching unit 703 of the extracted feature value. The second image data is image data generated by reading the written document with the reading device 110.

The feature matching unit 703 calculates the similarity between the feature value obtained from the first feature extraction unit 701 and the feature value obtained from the second feature extraction unit 702. Based on the calculated similarity, the feature matching unit 703 determines whether the unwritten document and the written document are documents of the same format. When the feature matching unit 703 determines that the unwritten document and the written document are not of the same format (when the matching fails), the feature matching unit 703 displays a message indicating that the matching has failed to the user via the user interface unit 121. The area setting process by the area setting unit 122 then ends.

When the feature matching unit 703 determines that the unwritten document and the written document are of the same format (when the matching succeeds), the feature matching unit 703 displays a message indicating that the matching has succeeded to the user via the user interface unit 121. The area setting process by the area setting unit 122 then continues.

### (2) Example of Process by Differential Image Generation Unit

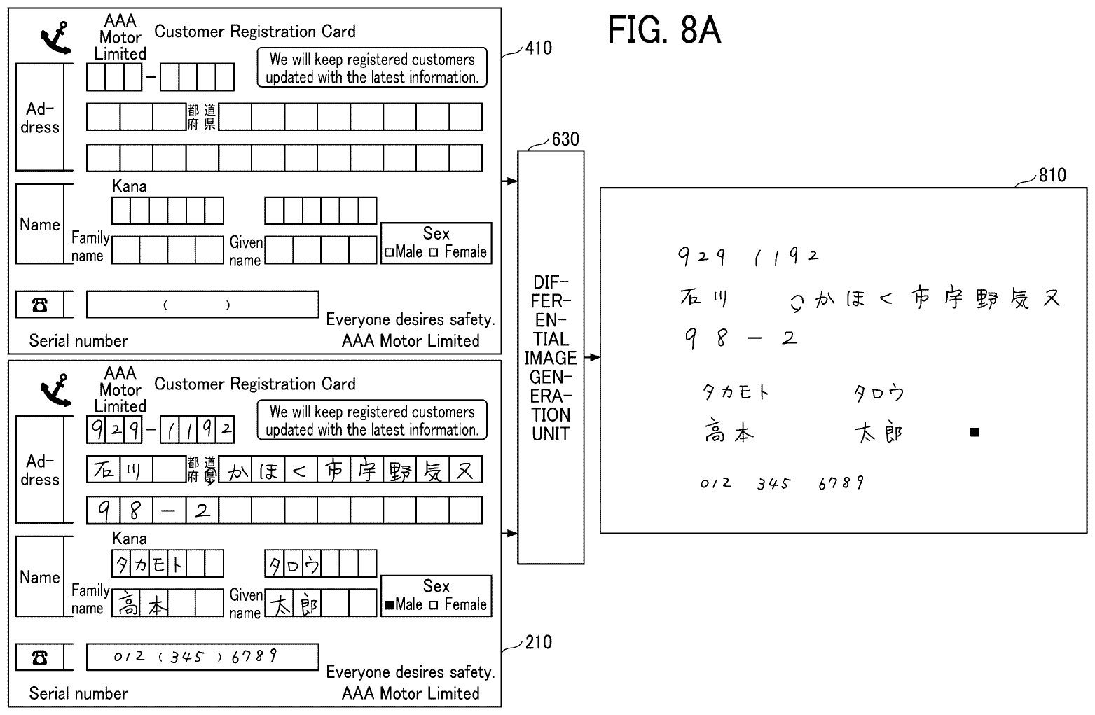

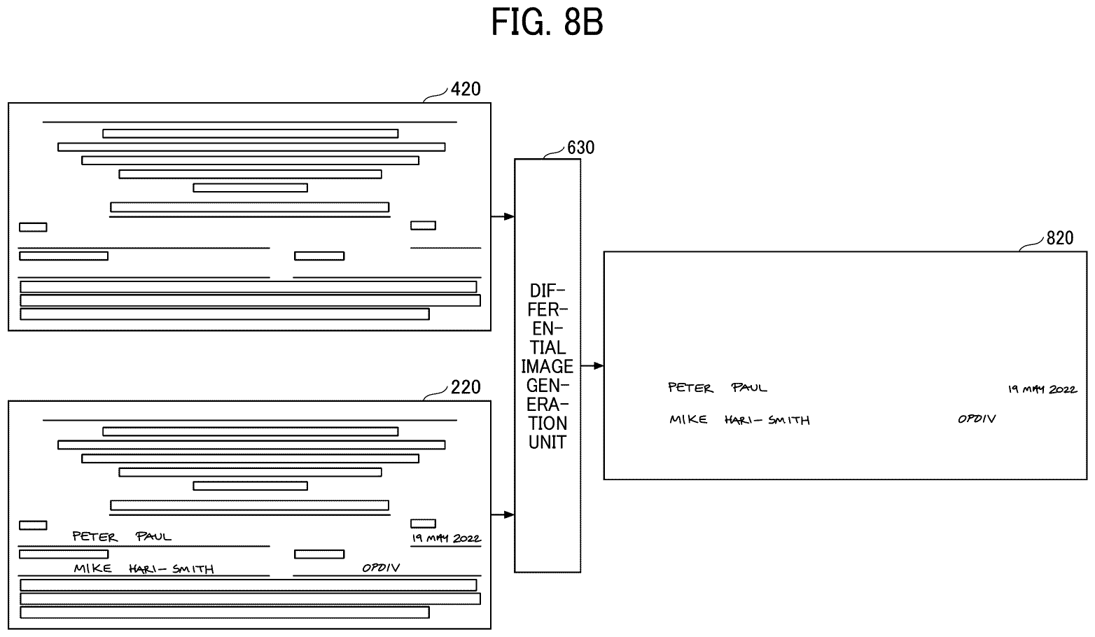

An example of a process performed by the differential image generation unit 630 is described below. FIG. 8A is a first diagram illustrating the example of the process performed by the differential image generation unit 630.

In FIG. 8A, the first image data 410 is the image data generated by reading the unwritten document with the reading device 110, and acquired by the image data acquisition unit 610. The second image data 210 is the image data generated by reading the written document with the reading device 110, and acquired by the image data acquisition unit 610.

As the first image data 410 and the second image data 210 are input to the differential image generation unit 630, the differential image generation unit 630 calculates the difference between the first image data 410 and the second image data 210 to generate the differential image data indicating the calculated difference. FIG. 8A illustrates the differential image data 810, which is generated based on the first image data 410 and the second image data 210.

FIG. 8B is a second diagram illustrating the example of the process performed by the differential image generation unit 630. In FIG. 8B, the first image data 420 is the image data generated by reading the unwritten document with the reading device 110, and acquired by the image data acquisition unit 610. The second image data 220 is the image data generated by reading the written document with the reading device 110, and acquired by the image data acquisition unit 610.

As the first image data 420 and the second image data 220 are input to the differential image generation unit 630, the differential image generation unit 630 calculates the difference between the first image data 420 and the second image data 220 to generate the differential image data indicating the calculated difference. FIG. 8B illustrates the differential image data 820, which is generated based on the first image data 420 and the second image data 220.

### (3) Example of Process by Character Recognition Processing Unit

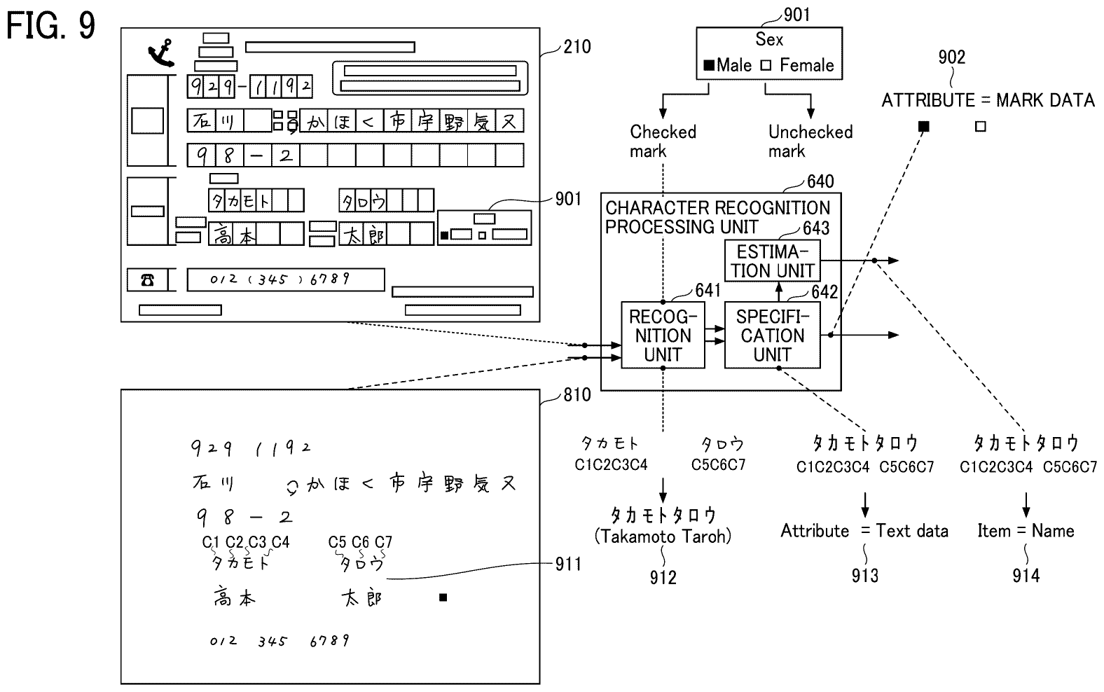

An example of a process performed by the character recognition processing unit 640 is described below. FIG. 9 is a diagram illustrating an example of the process performed by the character recognition processing unit 640.

As described above, the recognition unit 641 of the character recognition processing unit 640 executes the character recognition process on the second image data. The second image data 210 of FIG. 9 is the same as the second image data 210 of FIG. 8A.

FIG. 9 illustrates an example case in which the recognition unit 641 performs the character recognition process on an area 901 of the second image data 210, and obtains character information of “checked mark” and character information of “unchecked mark” as a character recognition result.

FIG. 9 further illustrates that the specification unit 642 determines that the character information of “checked mark” and the character information of “unchecked mark”, which are acquired as the character recognition result, each have the attribute of the mark data. As indicated by the reference numeral 902 of FIG. 9, the specification unit 642 transmits the notification to the setting unit 670, which indicates the area 901 of the character information having the attribute of the mark data.

As described above, the recognition unit 641 of the character recognition processing unit 640 executes the character recognition process on the differential image data. The differential image data 810 of FIG. 9 is the same as the differential image data 810 of FIG. 8A.

FIG. 9 illustrates the example case in which the recognition unit 641 executes the character recognition process on an area 911 of the differential image data 810. In FIG. 9, the reference numeral 912 describes that, as a result of performing the character recognition process on the area 911 by the recognition unit 641, the character information “C1”, “C2”, “C3”, “C4”, “C5”, “C6”, and “C7” are obtained as a character recognition result.

Still referring to FIG. 9, the reference numeral 913 indicates that the specification unit 642 determines that the attribute of the character information “C1”, “C2”, “C3”, “C4”, “C5”, “C6”, and “C7”, which are obtained as the character recognition result, indicates text data (not mark data).

Still referring to FIG. 9, the reference numeral 914 indicates that the estimation unit 643 determines that the item indicated by the character information “C1”, “C2”, “C3”, “C4”, “C5”, “C6”, and “C7” is a name, and notifies the setting unit 670 of the estimated item.

### (4) Example of Process by Shape Recognition Processing Unit

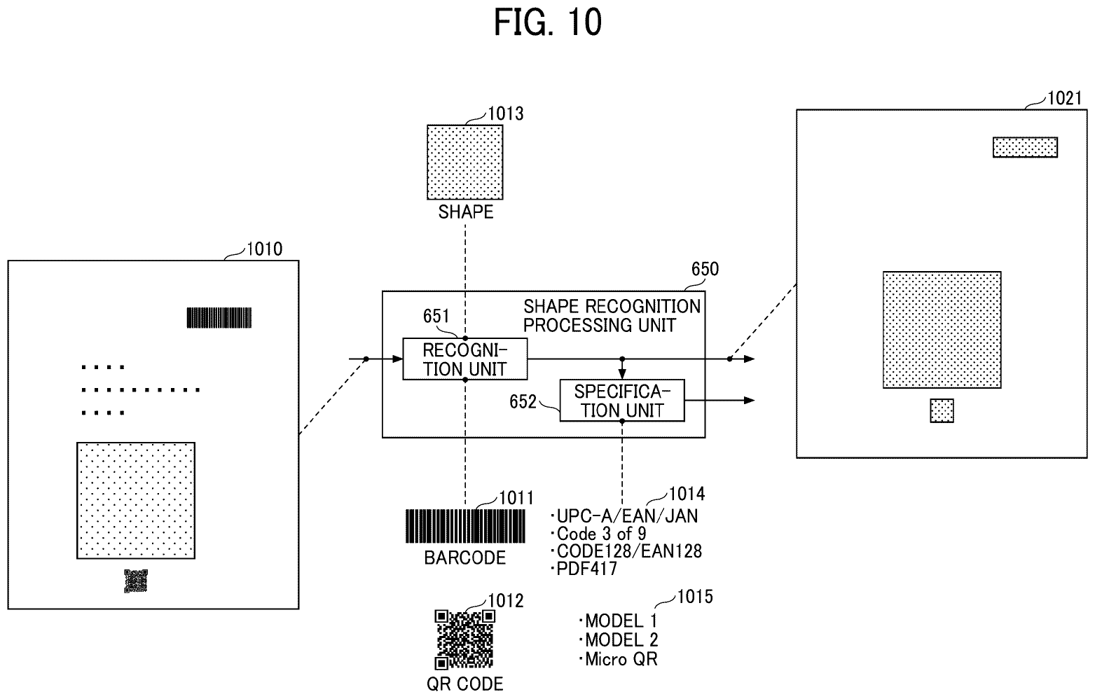

An example of a process performed by the shape recognition processing unit 650 is described below. FIG. 10 is a diagram illustrating an example of the process performed by the shape recognition processing unit 650.

As described above, the recognition unit 651 of the shape recognition processing unit 650 executes the shape recognition process on the second image data. FIG. 10 illustrates an example of second image data 1010, which is generated by reading the written document with the reading device 110, and includes a plurality of pieces of information other than the character information in addition to or in alternative to the character information. For the descriptive purpose, the following description assumes that the image data is generated by reading a document including images and codes using the reading device 110.

As illustrated in FIG. 10, the recognition unit 651 performs the shape recognition process on the second image data 1010, and recognizes a barcode 1011, a QR code 1012, and a geometric shape (“shape”) 1013 in the second image data 1010.

In FIG. 10, as indicated by the reference numeral 1021, the recognition unit 651 performs the shape recognition process on the second image data 1010 to obtain the code information and the image information (the barcode 1011, the QR code 1012, and the shape 1013). As indicated by the reference numeral 1021, the recognition unit 651 notifies the setting unit 670 of the areas of the code information and the image information (the barcode 1011, the QR code 1012, and the shape 1013) having been obtained.

FIG. 10 illustrates an example case in which the specification unit 652 determines that the type of the barcode 1011, which is acquired by the recognition unit 651 as a result of executing the recognition process, is one of the types indicated by the reference numeral 1014.

Similarly, FIG. 10 illustrates an example case in which the specification unit 652 determines that the type of the QR code 1012, which is acquired by the recognition unit 651 as a result of executing the recognition process, is one of the types indicated by the reference numeral 1015.

### (5) Example of Process by Setting Unit (Character Information)

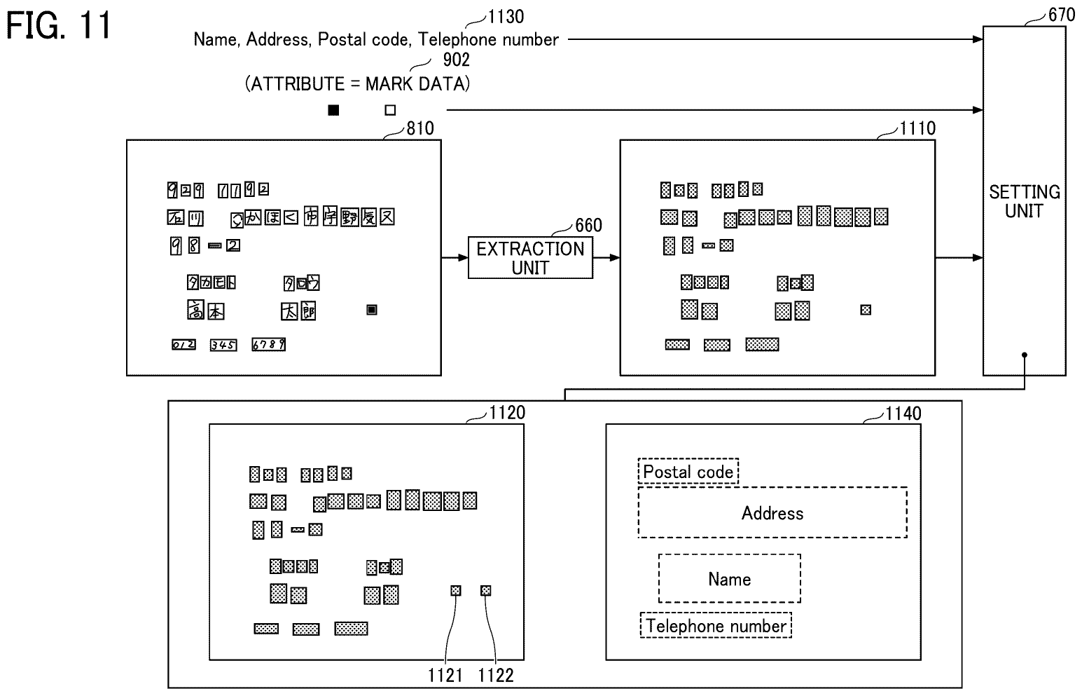

An example of a process related to character information, performed by the setting unit 670, is described below. FIG. 11 is a first diagram illustrating an example of the process performed by the setting unit 670.

As described above, when the setting unit 670 performs the process related to character information, the extraction unit 660 extracts the candidate areas to be digitized based on the differential image data notified by the differential image generation unit 630, and notifies the setting unit 670 of the extracted candidate areas to be digitized. The specification unit 642 of the character recognition processing unit 640 notifies the setting unit 670 of the area of the character information having the attribute of the mark data. The estimation unit 643 of the character recognition processing unit 640 notifies the setting unit 670 of the item indicated by the character information having the attribute of the text data.

The differential image data 810 of FIG. 11 is the same as the differential image data 810 of FIG. 8A. In FIG. 11, as indicated by the reference numeral 902, the attribute of the character information is determined to indicate the mark data, as described above referring to the character information indicated by the reference numeral 902 of FIG. 9.

FIG. 11 illustrates a plurality of rectangles 1110 each extracted from the differential image data 810 as a candidate area to be digitized.

Still referring to FIG. 11, the setting unit 670 sets a plurality of rectangles 1120 each as the area to be digitized, based on the rectangles 1110 that are extracted from the differential image data 810 as the candidate area to be digitized, and the area of the character information having the attribute of the mark data (indicated by the reference numeral 902).

Of the rectangles 1120, the rectangles 1121 and 1122 correspond to the areas to be digitized, which are set based on the character information having the attribute of the mark data as represented by the reference numeral 902. An area indicated by the rectangle 1121 is also one of the candidate areas to be digitized, which are extracted by the extraction unit 660 based on the differential image data 810. The setting unit 670 overwrites the candidate area to be digitized, which is represented by the rectangle 1110, in the differential image data 810, with the rectangle 1121. On the other hand, an area indicated by the rectangle 1122 is not included in the candidate areas to be digitized (represented by the rectangles 1110), which are extracted by the extraction unit 660 based on the differential image data 810. In other words, if the area of the character information having the attribute of the mark data (indicated by the reference numeral 902) is not set, the area indicated by the rectangle 1122 would not be set as the area to be digitized.

As described above, the setting unit 670 sets the areas to be digitized, which are assumed to include the character information, based on the candidate areas to be digitized that are extracted based on the differential image data and the character recognition result of the second image data. Accordingly, the setting unit 670 can set all areas having the character information without omission, as the areas to be digitized.

FIG. 11 further illustrates the items 1130 indicated by the character information having the attribute that is determined to indicate the text data. As indicated by the reference numeral 1140 of FIG. 11, the setting unit 670 sets the items 1130 indicated by the character information having the attribute of the text data, in association with the areas to be digitized that are represented by the rectangles 1120.

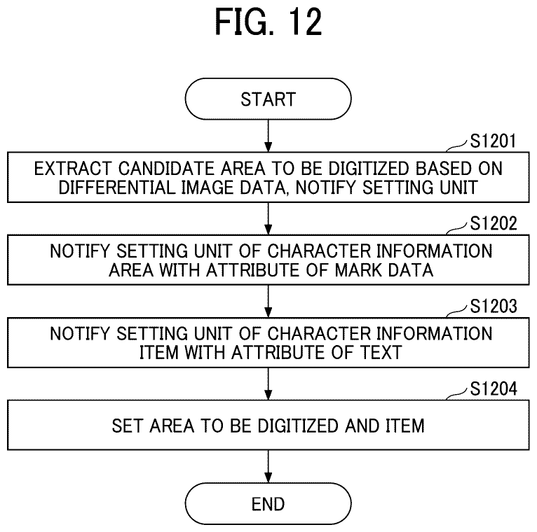

FIG. 12 is an example of a first flowchart of processes performed by the setting unit 670.

In step S1201, the extraction unit 660 extracts one or more candidate areas to be digitized based on the obtained differential image data, and notifies the setting unit 670 of the candidate areas to be digitized.

In step S1202, the specification unit 642 of the character recognition processing unit 640 notifies the setting unit 670 of the area of the character information having the attribute of the mark data.

In step S1203, the estimation unit 643 of the character recognition processing unit 640 notifies the setting unit 670 of the item indicated by the character information having the attribute of the text data.

In step S1204, the setting unit 670 sets the candidate areas to be digitized, which are notified in step S1201, and the area of the character information notified in step S1202, as the areas to be digitized. The setting unit 670 further sets the item notified in step S1203 in association with the area to be digitized.

### (6) Example of Process by Setting Unit (Code Information and Image Information)

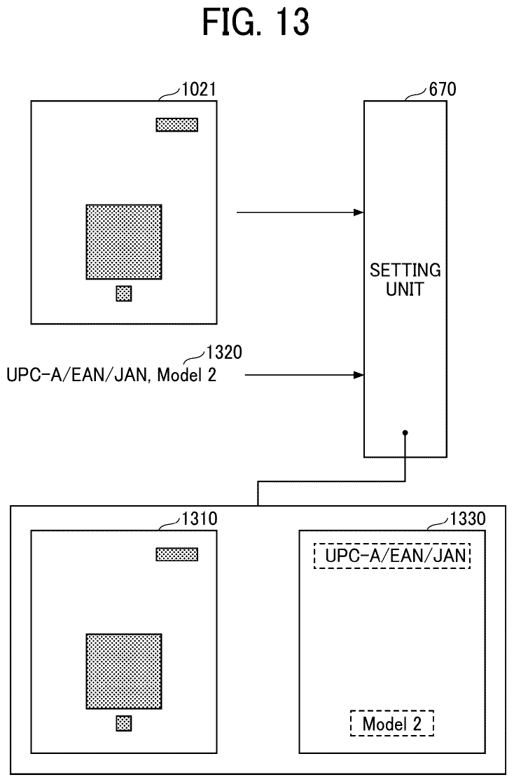

An example of a process related to the code information and the image information, performed by the setting unit 670, is described below. FIG. 13 is a second diagram illustrating an example of the process performed by the setting unit 670.

As described above, the recognition unit 651 of the shape recognition processing unit 650 notifies the setting unit 670 of the area of the code information and the area of the image information. Further, the specification unit 652 of the shape recognition processing unit 650 notifies the setting unit 670 of the type of the code information.

In FIG. 13, as indicated by the reference numeral 1021, the area of the code information and the area of the image information are obtained, in a substantially similar manner as described above for the example case of the area of the code information and the area of the image information indicated by the reference numeral 1021 of FIG. 10. As indicated by the reference numeral 1310 of FIG. 13, the setting unit 670 sets the area of the code information and the area of the image information that are indicated by the reference numeral 1021 as the areas to be digitized.

As described above, the setting unit 670 sets the area of the code information and the area of the image information as the areas to be digitized based on the shape recognition result of the second image data.

In FIG. 13, the reference numeral 1320 describes the types of the code information. As indicated by the reference numeral 1330 of FIG. 13, the setting unit 670 sets the type of the code information in association with the area to be digitized.

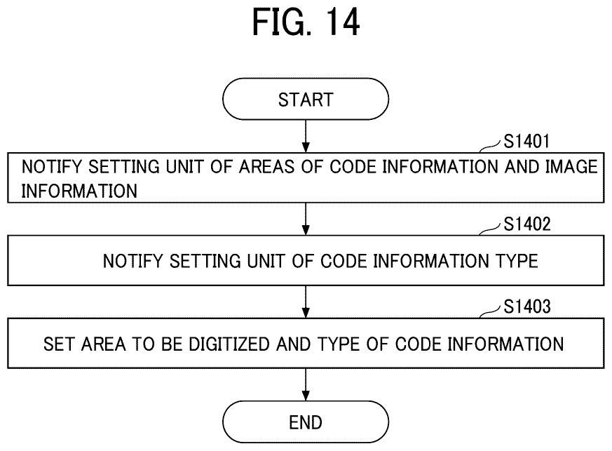

FIG. 14 is an example of a second flowchart of processes performed by the setting unit 670.

In step S1401, the recognition unit 651 of the shape recognition processing unit 650 notifies the setting unit 670 of the area of the code information and the area of the image information.

In step S1402, the specification unit 652 of the shape recognition processing unit 650 notifies the setting unit 670 of the type of the code information.

In step S1403, the setting unit 670 sets the area of the code information and the area of the image information, each notified in step S1401, as the areas to be digitized. The setting unit 670 further sets the type of the code information notified in step S1402 in association with the area to be digitized.

### (7) Example of Process by Area Adjusting Unit

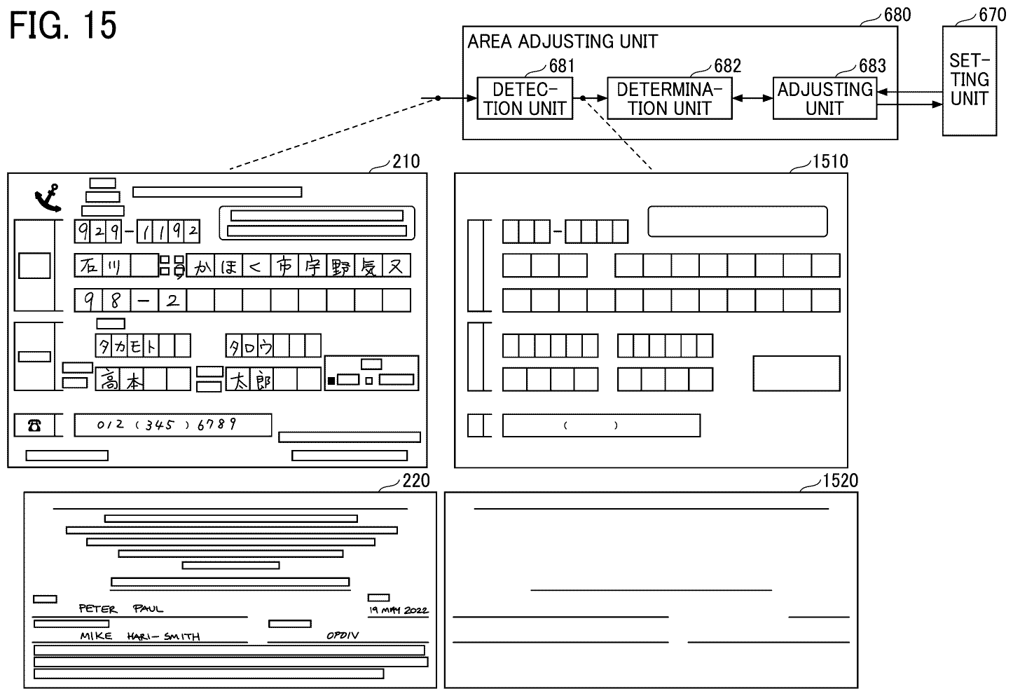

An example of a process performed by the area adjusting unit 680 is described below. The example of the process related to character information, performed by the area adjusting unit 680, is described with reference to FIGS. 15 to 19. FIG. 15 is a diagram illustrating an example of the process performed by the area adjusting unit 680.

As described above, the setting unit 670 sets, as the area to be digitized for the character information, the candidate areas to be digitized that are notified by the extraction unit 660 and the area of the character information having the attribute of the mark data that is notified by the character recognition processing unit 640. The detection unit 681 performs the line segment detection process on the second image data to detect one or more line segments in the second image data. The adjusting unit 683 determines the type of the detected line segment based on the positional relationship between the detected line segment and the set area to be digitized, and adjusts the shape of the area to be digitized based on the determined type.

The second image data 210 of FIG. 15 is the same as the second image data 210 of FIG. 8A. FIG. 15 illustrates line segments 1510 detected by executing the line segment detection process on the second image data 210.

The second image data 220 of FIG. 15 is the same as the second image data 220 of FIG. 8B. FIG. 15 further illustrates line segments 1520 detected by executing the line segment detection process on the second image data 220.

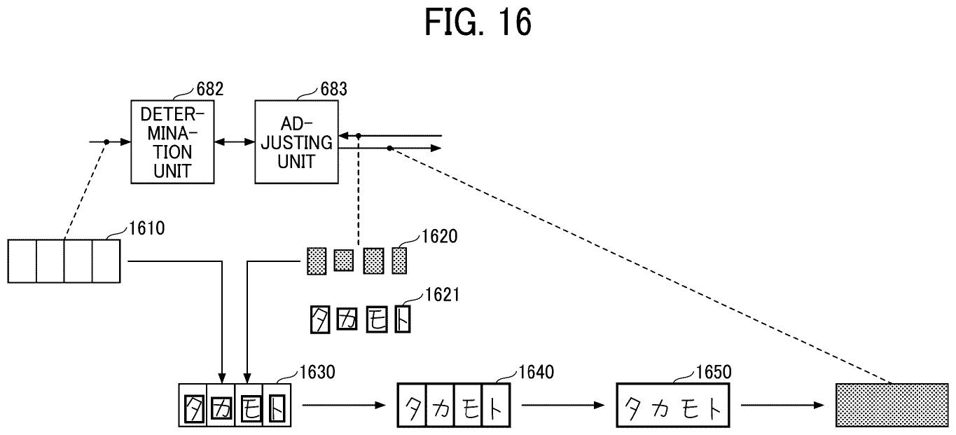

FIG. 16 is a diagram illustrating a first example of a process performed by the adjusting unit 683. Specifically, FIG. 16 illustrates an example of the process performed by the adjusting unit 683 when the determination unit 682 determines that the type of the detected line segment is a rectangular frame. FIG. 16 illustrates line segments 1610, which are a part of the line segments 1510 of FIG. 15. FIG. 16 further illustrates areas 1620 to be digitized, which are present at a location corresponding to the line segments 1610. FIG. 16 further illustrates differential image data 1621 of the areas 1620 when the areas 1620 are set as the areas to be digitized.

In FIG. 16, the determination unit 682 determines that the line segment 1610 represents a rectangular frame that encompasses each area 1620 to be digitized, based on the positional relationship 1630 between the line segment 1610 and the area 1620 to be digitized.

When the adjusting unit 683 determines that the detected line segment represents a rectangular frame that encompasses the area to be digitized, the adjusting unit 683 adjusts the area to be digitized, such that the area to be digitized is made larger in size to just fit in the smallest rectangular frame that can encompass the area to be digitized. FIG. 16 illustrates adjusted areas 1640 to be digitized, each of which is generated by enlarging the size of the area 1620 to be digitized to fit in the smallest rectangular frame, which is represented by the line segment 1610 and can encompass the area 1620 to be digitized.

As a result of adjusting the areas 1620 to be digitized to enlarge their sizes, the adjusting unit 683 determines whether two or more of the adjusted areas 1640 to be digitized that are adjacent to each other satisfy a predetermined merge condition. The adjusting unit 683 determines that the adjacent areas satisfy the predetermined merge condition when the adjacent areas satisfy any of the following conditions.

First, the distance between the adjacent areas is equal to or less than a predetermined threshold

Second, the adjacent areas are in contact with each other.

Third, the adjacent areas partially overlap each other.

When the adjusting unit 683 determines that the adjacent areas satisfy the predetermined merge condition, the adjusting unit 683 merges the adjacent areas to adjust a shape of the areas to be digitized.

FIG. 16 illustrates an adjusted area 1650 to be digitized, which is generated by merging the adjacent areas.

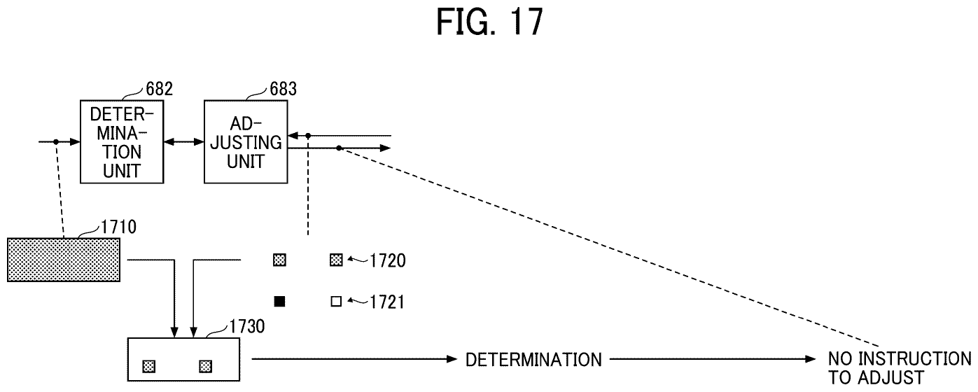

FIG. 17 is a diagram illustrating a second example of a process performed by the adjusting unit 683. Specifically, FIG. 17 illustrates another example of the process performed by the adjusting unit 683 when the determination unit 682 determines that the type of the detected line segments is a rectangular frame. FIG. 17 illustrates a line segment 1710, which is a part of the line segments 1510 of FIG. 15. FIG. 17 further illustrates areas 1720 to be digitized, which are present at a location corresponding to the line segment 1710. FIG. 17 further illustrates the character information 1721 of the area 1720, when the areas 1720 are set as the areas to be digitized. The character information 1721 has the attribute of the mark data.

In FIG. 17, the determination unit 682 determines that the line segment 1710 represents a rectangular frame that encompasses the areas 1720 to be digitized, based on the positional relationship 1730 between the line segment 1710 and the areas 1720 to be digitized.

When the adjusting unit 683 determines that the detected line segment represents a rectangular frame that encompasses the areas to be digitized, the adjusting unit 683 determines whether the size of the area to be digitized is equal to or smaller than a first threshold, and whether the proportion of the area to be digitized to the area of the rectangular frame is equal to or less than a second threshold. When the determination result indicates that the size of the area to be digitized is equal to or smaller than the first threshold and the proportion of the area to be digitized to the area of the rectangular frame is equal to or less than the second threshold, the adjusting unit 683 determines not to adjust the area to be digitized. When the determination result indicates that the size of the area to be digitized is greater than the first threshold and the proportion of the area to be digitized to the area of the rectangular frame is greater than the second threshold, the adjusting unit 683 determines to adjust the area to be digitized in a similar manner as described above referring to FIG. 16.

FIG. 17 illustrates an example case in which the adjusting unit 683 determines that the size of the area 1720 to be digitized is equal to or smaller than the first threshold, and the proportion of the area 1720 to be digitized to the area of the rectangular frame is equal to or less than the second threshold (see “DETERMINATION” in FIG. 17).

Accordingly, the adjusting unit 683 does not instruct to adjust the area 1720 to be digitized.

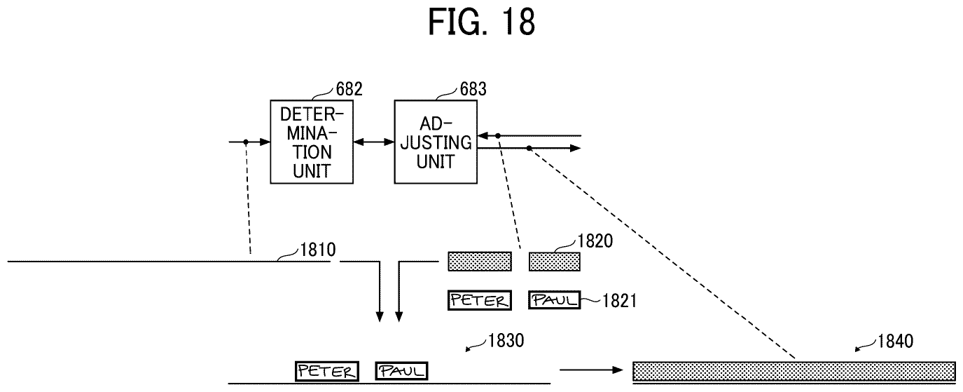

FIG. 18 is a diagram illustrating a third example of the process performed by the adjusting unit 683. Specifically, FIG. 18 illustrates the example of the process performed by the adjusting unit 683 when the determination unit 682 determines that the type of the detected line segments is an under line. FIG. 18 illustrates a line segment 1810, which is a part of the line segments 1520 of FIG. 15. FIG. 18 further illustrates areas 1820 to be digitized, which are present at a location corresponding to the line segment 1810. FIG. 18 further illustrates differential image data 1821 of the areas 1820 when the areas 1820 are set as the areas to be digitized.

In FIG. 18, the determination unit 682 determines that the area 1820 to be digitized is an area including the underline represented by the line segment 1810, based on the positional relationship 1830 between the line segment 1810 and the area 1820 to be digitized.

When the adjusting unit 683 determines that the area to be digitized is an area having the underline, the adjusting unit 683 adjusts the area to be digitized by enlarging the area, both in the horizontal direction to match the length of the underline and in the vertical direction to match the height of other areas to be digitized that are present above the underline. The horizontal direction is a direction to which the underline extends in length, and may include the direction nearly horizontal. The vertical direction is a direction orthogonal to the direction to which the underline extends in length, and may include the direction nearly vertical.

FIG. 18 illustrates an adjusted area 1840 to be digitized, which is generated by enlarging the size of the areas 1820 to be digitized, in the horizontal direction to match the length of the underline represented by the line segment 1810 and in the vertical direction to match the height of other areas to be digitized that are present above the underline represented by the line segment 1810.

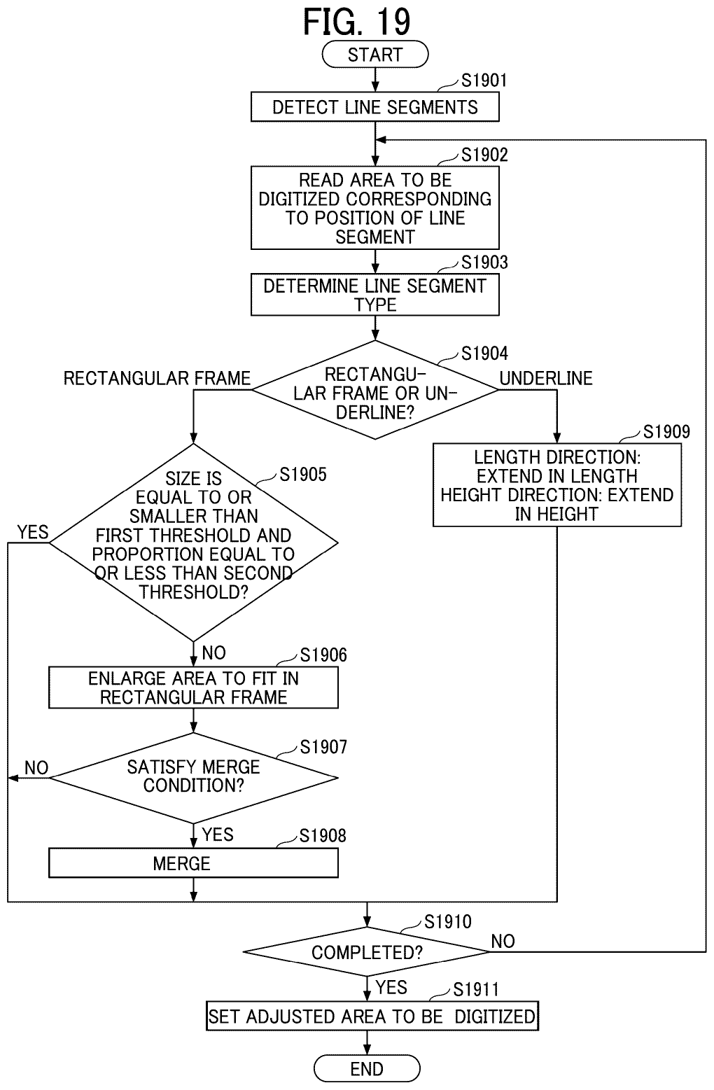

FIG. 19 is an example of a flowchart of processes performed by the area adjusting unit 680.

In step S1901, the area adjusting unit 680 performs the line segment detection process on the second image data to detect one or more line segments from the second image data.

In step S1902, the area adjusting unit 680 reads out from the setting unit 670 one or more areas to be digitized, which are located at the position corresponding to the line segment subjected to processing.

In step S1903, the area adjusting unit 680 determines a type of the line segment based on the positional relationship between the line segment and the read areas to be digitized.

In step S1904, the area adjusting unit 680 determines whether the type of the line segment represents a rectangular frame or an underline. When it is determined in step S1904 that the line segment represents the rectangle frame, the operation proceeds to step S1905.

In step S1905, the area adjusting unit 680 determines whether the size of the area to be digitized read in step S1902 is equal to or smaller than the first threshold, and the proportion of the area to be digitized in the rectangular frame is equal to or less than a second threshold. In step S1905, when it is determined that the size of the area to be digitized is equal to or smaller than the first threshold and the proportion of the area to be digitized in the rectangular frame is equal to or less than the second threshold (YES in step S1905), the operation proceeds to step S1910.

In step S1905, when it is determined that the size of the area to be digitized is greater than the first threshold and the proportion of the area to be digitized in the rectangular frame is greater than the second threshold (NO in step S1905), the operation proceeds to step S1906.

In step S1906, the area adjusting unit 680 performs adjustment to enlarge the size of the area to be digitized, so that the area to be digitized just fits inside the rectangular frame.

In step S1907, the area adjusting unit 680 determines whether two or more of the adjusted areas to be digitized after enlarging in step S1906, which are adjacent with each other, satisfies a predetermined merge condition. In step S1907, when it is determined that the predetermined merge condition is not satisfied (NO in step S1907), the operation proceeds to step S1910. When it is determined in step S1907 that the predetermined merge condition is satisfied (YES in step S1907), the operation proceeds to step S1908.

In step S1908, the area adjusting unit 680 merges the adjusted areas to be digitized, which are adjacent to each other and are determined to satisfy the predetermined merge condition.

When it is determined in step S1904 that the line segment represents the underline, the operation proceeds to step S1909. In step S1909, the area adjusting unit 680 adjusts the area to be digitized by enlarging the area, both in the horizontal direction to match the length of the underline and in the vertical direction to match the height of other areas to be digitized that are present above the underline.

In step S1910, the area adjusting unit 680 determines whether the processes of the steps S1902 to S1909 have been executed for all the line segments detected in step S1901. In step S1910, when it is determined that there is a line segment for which the processes have not been performed (NO in step S1910), the line segment for which the processes have not been performed is selected as the line segment to be processed, and the operation returns to step S1902.

On the other hand, when the area adjusting unit 680 determines in step S1910 that the processes have been performed for all line segments (YES in step S1910), the operation proceeds to step S1911.

In step S1911, the area adjusting unit 680 sets the areas to be digitized having been adjusted, and ends the adjusting process.

### Area Setting Process by Reading System

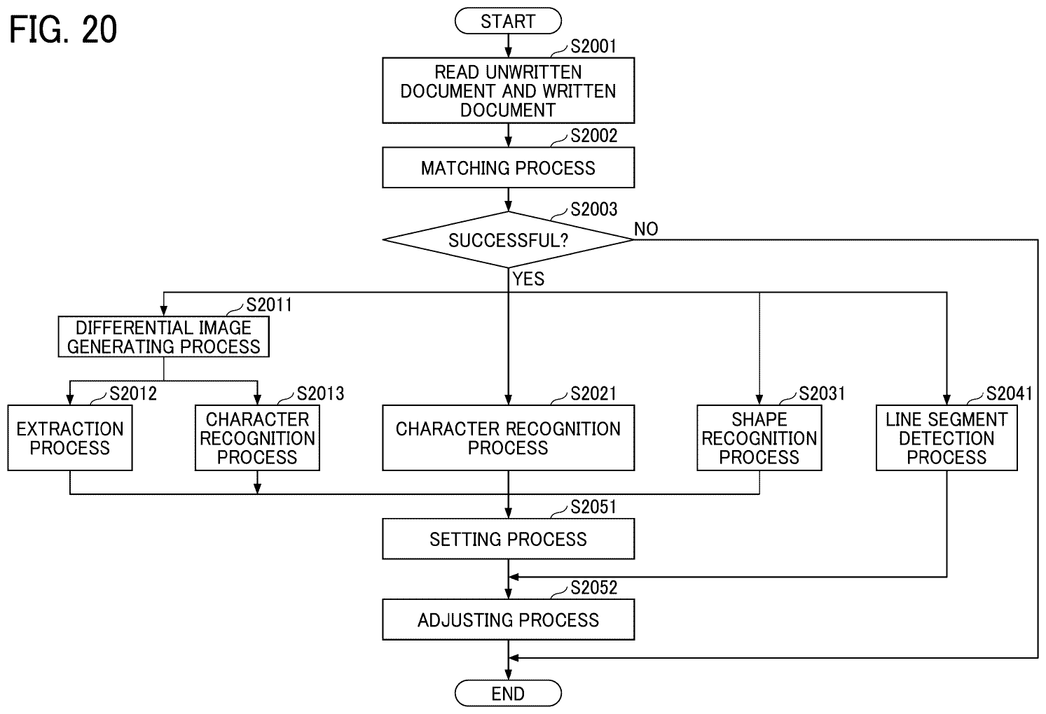

The area setting process performed by the reading system 100 is described below. FIG. 20 is an example of a flowchart of the area setting process performed by the reading system 100.

In step S2001, the reading device 110 reads an unwritten document and a written document, generates first image data and second image data, and transmits the first image data and the second image data to the information processing apparatus 120.

In step S2002, the information processing apparatus 120 executes the matching process on the first image data and the second image data transmitted from the reading device 110.

In step S2003, the information processing apparatus 120 determines whether the matching process in step S2002 is successful. When it is determined that the matching process in step S2002 has failed (NO in step S2003), the area setting process ends. When it is determined that the matching process in step S2002 is successful (YES in step S2003), the operation proceeds to steps S2011 to S2041.

In step S2011, the information processing apparatus 120 executes the differential image generation process to generate differential image data based on the first image data and the second image data.

In step S2012, the information processing apparatus 120 executes the extraction process to extract candidate areas to be digitized from the differential image data.

In step S2013, the information processing apparatus 120 executes the character recognition process on the differential image data and estimates an item indicated by the character information having the attribute of text.

In step S2021, the information processing apparatus 120 executes the character recognition process on the second image data and determines character information having the attribute of mark data.

In step S2031, the information processing apparatus 120 executes the shape recognition process on the second image data to recognize code information and image information, and to determine the type of the code information.

In step S2041, the information processing apparatus 120 executes the line segment detection process on the second image data to detect one or more line segments.

In step S2051, the information processing apparatus 120 sets, as the areas to be digitized, the candidate areas to be digitized that are extracted in step S2012, the area of the character information that is determined in step S2021, and the area of the code information and the area of the image information that are recognized in step S2031.

The information processing apparatus 120 further sets the item indicated by the character information recognized in step S2013 and the type of the code information determined in step S2031 in association with the areas to be digitized.

In step S2052, the information processing apparatus 120 adjusts the areas to be digitized based on the line segments detected in step S2041, and ends the area setting process.

### Example of Setting Screen in Area Setting Process

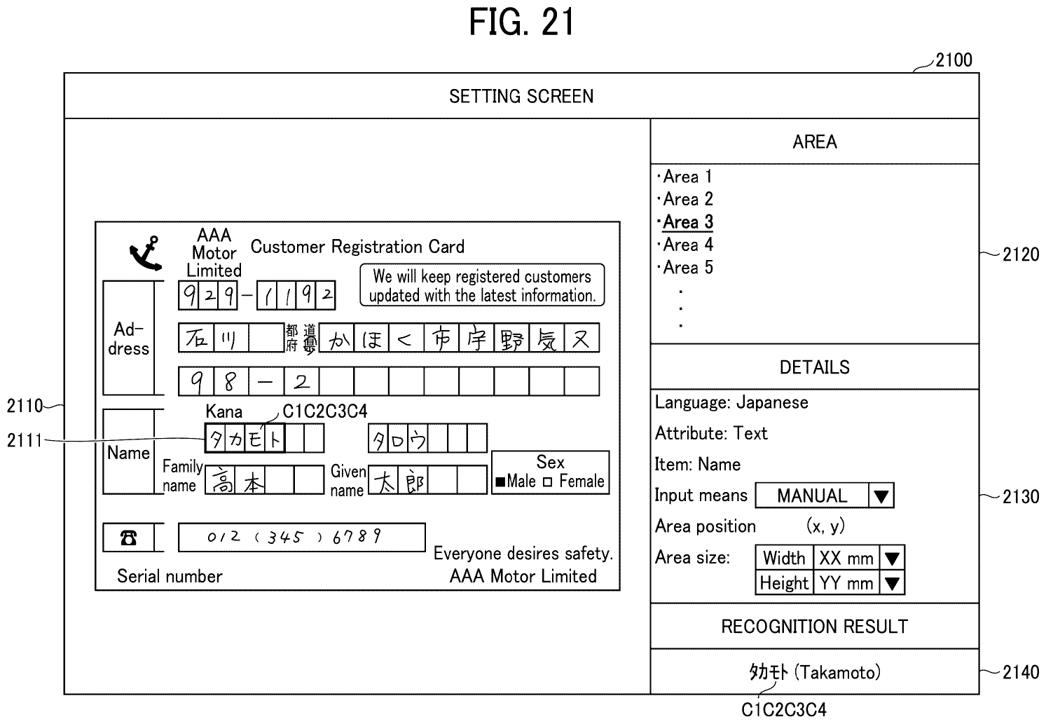

The following describes a setting screen, which is displayed on the display device 512 connected to the information processing apparatus 120 via the user interface unit 121 in the area setting process performed by the reading system 100. FIG. 21 is a diagram illustrating an example of a setting screen in the area setting process.

As illustrated in FIG. 21, a setting screen 2100 includes a second image data display section 2110, an area display section 2120, a detailed area information display section 2130, and a recognition result display section 2140.

In the second image data display section 2110, the second image data generated by reading the written document with the reading device 110 is displayed. The second image data display section 2110 further displays an area frame 2111 superimposed on the second image data to indicate an area designated by the user.

The area display section 2120 displays the areas to be digitized, which are set by the reading system 100 that executes the area setting process. When the user selects one of the areas to be digitized displayed in the area display section 2120, the area frame 2111 corresponding to the selected area is displayed, while being superimposed on the second image data in the second image data display section 2110. FIG. 21 illustrates an example case in which the user selects the “area 3” from among the areas to be digitized being displayed in the area display section 2120, and the second image data display section 2110 displays the area frame 2111 superimposed on the second image data.

The detailed area information display section 2130 displays detailed information about the area, which is designated by the user from among the areas to be digitized. FIG. 21 illustrates that, in response to the selection of the “area 3” by the user from among the areas to be digitized displayed in the area display section 2120, the detailed area information display section 2130 displays information previously associated with the “area 3”. Specifically, the detailed area information display section 2130 of FIG. 21 describes the following.

With the execution of the character recognition process on the area, the character information written in the area is determined to be Japanese, so that the language of Japanese is set in association with the area.

With the execution of the character recognition process on the area, the attribute of the character information written in the area is determined to be text, so that the attribute of text is set in association with the area.

With the execution of the character recognition process on the area, the item indicated by the character information written in the area is determined to be a name, so that the item of name is set in association with the area.

The “manual” for the input means indicates that handwriting is set as the writing method for the text information to be written in the area.

The position of the area is set to (x, y). The size of the area is set to have the width of XX mm and the height of YY mm.

In the detailed area information display section 2130, of the information set in association with the “area 3”, the language, attribute, item, and area size are automatically set by the setting unit 670. The writing method is set by the user. Further, the area size is automatically set by the setting unit 670 and may be freely changed by the user.

The recognition result display section 2140 displays the recognition result of the area, which is designated by the user from among the areas to be digitized. FIG. 21 illustrates that, of the areas to be digitized displayed in the area display section 2120, the “area 3” has been designated by the user. Accordingly, the recognition result of the character recognition process performed for that area, which are the characters “C1, C2, C3, C4”, is displayed in the recognition result display section 2140.

The user can check if the recognition result being displayed in the recognition result display section 2140 is accurate. For example, the user can determine if the position and size of the area to be digitized, which has been set by the user, are accurately recognized.

As described above, the information processing apparatus 120 extracts the candidate areas to be digitized, based on the difference between the first image data generated based on the unwritten document and the second image data generated based on the written document.

The information processing apparatus 120 further executes the character recognition process or the shape recognition process on the second image data to obtain the recognition result.

The information processing apparatus 120 then sets the areas to be digitized based on the candidate areas to be digitized and the recognition result.

The information processing apparatus 120 can reduce the amount of user interaction required when setting the areas to be digitized. This enhances the operability of the reading system 100 in performing the setting operation by the user.

### Modified Example

In the above-described embodiment, the areas to be digitized, which are set by the setting unit 670, include one or more areas each set by executing the process related to the character information, and one or more areas each set by executing the process related to the mark data or the image information. The above-described embodiment describes the case where the areas of the character information and the areas of the mark data or the image information do not overlap with each other.

As described above, in the case of the areas to be digitized that are set by executing the process related to the character information, the adjusting unit 683 may adjust the areas based on the detected line segments. The areas to be digitized, which have been enlarged by the adjustment, may overlap with the other areas to be digitized.

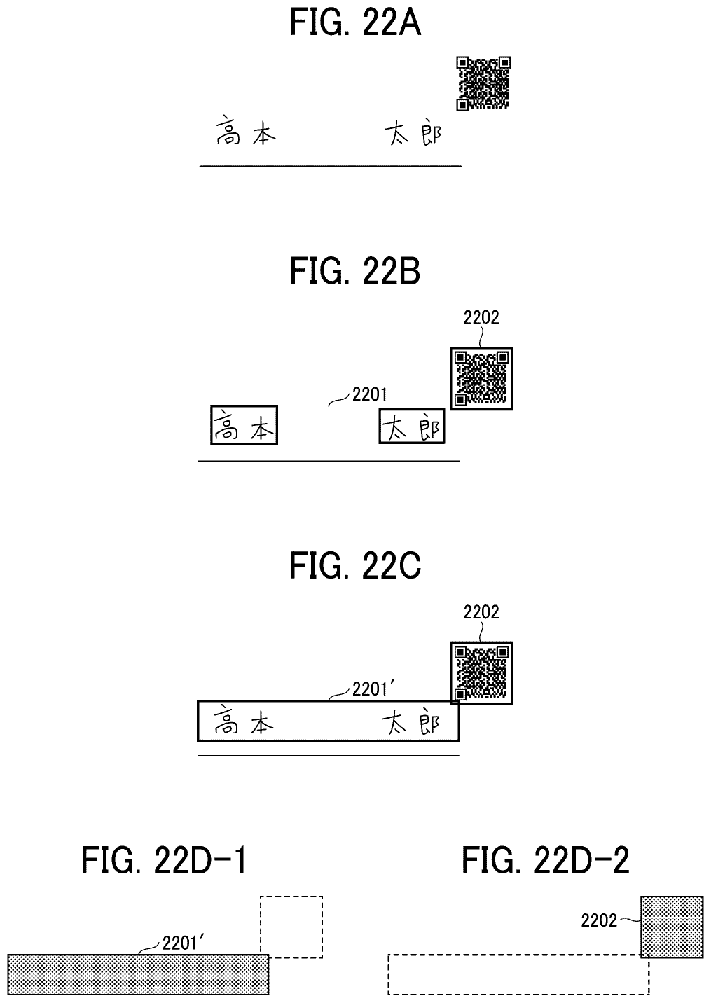

FIGS. 22A, 22B, and 22C are diagrams illustrating a fourth example of the process performed by the adjusting unit 683. FIG. 22A is a part of second image data generated by reading a document with the reading device 110. In the document, the position where the name is to be written (the position indicated by the underline) and the position of the mark data are relatively close to each other.

Assuming that the area setting process is performed on the second image data illustrated in FIG. 22A, as illustrated in FIG. 22B, the setting unit 670 sets an area 2201 and an area 2202 as the areas to be digitized.

When the detection unit 681 detects the underline, the adjusting unit 683 adjusts the area 2201 set by the setting unit 670 to generate an adjusted area 2201′, which is set as the area to be digitized.

It is assumed that, as illustrated in FIG. 22C, a part of the adjusted area 2201′ to be digitized, and a part of the area 2202 to be digitized overlap with each other. In such a case, the setting unit 670 determines the information to be set in association with the area to be digitized, based on the proportion of the overlapping portion in the area to be digitized.

FIG. 22D-1 is a diagram illustrating the relationship between the adjusted area 2201′ to be digitized and the overlapping portion. In the example of FIG. 22D-1, since the proportion of the overlapping portion in the adjusted area 2201′ to be digitized is less than a predetermined threshold, the setting unit 670 determines that the attribute set for the adjusted area 2201′ to be digitized indicates text data.

FIG. 22D-2 is a diagram illustrating the relationship between the area 2202 to be digitized and the overlapping portion. In the example of FIG. 22D-2, since the proportion of the overlapping portion in the area 2202 to be digitized is less than a predetermined threshold, the setting unit 670 determines that the information set for the area 2202 to be digitized is code information.

As described above, when the areas to be digitized overlap, the information to be set in association with each of the areas to be digitized is determined based on the proportion of the overlapping portion.

In the above-described embodiment, the information processing apparatus 120 and the reading device 110 are configured as separate apparatuses. Alternatively, a part of or all of the functional units of the reading device 110 may be implemented by the information processing apparatus 120. In other words, the information processing apparatus 120 may be configured as an apparatus separate from the reading device 110, or may incorporate the reading device 110.

In the above-described embodiment, the information processing program is executed by the information processing apparatus 120 that is implemented by a computer. Alternatively, the information processing apparatus 120 may be configured as a plurality of computers. At least a part of or all of the information processing program may be installed or executed by one or more of the computers, so that the information processing program is executed in the distributed computing environment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising
circuitry configured to:
extract one or more candidate areas to be digitized, based on a difference between first image data generated based on an unwritten document and second image data generated based on a written document;
execute a character recognition process or a shape recognition process on the second image data to obtain a recognition result; and
set one or more areas to be digitized based on the candidate areas to be digitized and the recognition result.

2. The information processing apparatus according to claim 1, wherein, when character information is obtained as the recognition result of executing the character recognition process, the circuitry is configured to
specify an attribute of the character information, and
estimate an item indicated by the character information when the attribute of the character information is specified to indicate text.

3. The information processing apparatus according to claim 2, wherein, when the attribute of the character information obtained by executing the character recognition process indicates mark data, the circuitry is configured to
extract an area of the character information as the candidate area to be digitized, and
set the extracted area of the character information as the area to be digitized.

4. The information processing apparatus according to claim 2, wherein the circuitry is configured to estimate the item using a machine-learned classifier.

5. The information processing apparatus according to claim 2, wherein the circuitry is configured to estimate the item based on a notation rule corresponding to a preset item.

6. The information processing apparatus according to claim 2, wherein the circuitry is configured to set the item indicated by the character information included in the area to be digitized.

7. The information processing apparatus according to claim 1, wherein, when code information is obtained as the recognition result of executing the shape recognition process, the circuitry is configured to specify a type of the code information.

8. The information processing apparatus according to claim 7, wherein the circuitry is configured to set the type of the code information included in the area to be digitized.

9. The information processing apparatus according to claim 1, wherein, when image information is obtained as the recognition result of executing the shape recognition process,
the circuitry is configured to set an area that corresponds to the image information from among the candidate areas, as the area to be digitized.

10. The information processing apparatus according to claim 2, wherein the circuitry is configured to:
detect one or more line segments in the second image data;
determine whether the area to be digitized is an area having a rectangular frame or an area having an underline based on the detected line segments; and
adjust a shape of the area to be digitized based on a result of the determination.

11. The information processing apparatus according to claim 10, wherein, when the result of the determination indicates that the area to be digitized includes a rectangular frame,
the circuitry is configured to adjust the area to be digitized by enlarging the area to be digitized such that the adjusted area fits inside a smallest rectangular frame that encompasses the area to be digitized.

12. The information processing apparatus according to claim 11, wherein, when two or more adjacent areas of the adjusted areas to be digitized having been enlarged satisfy a predetermined condition, the circuitry is configured to merge the adjacent areas.

13. The information processing apparatus according to claim 10, wherein, when the area to be digitized is determined to include an underline,
the circuitry is configured to enlarge the area to be digitized, both in the horizontal direction to match the length of the underline, and in the vertical direction to match the height of other areas to be digitized that are present above the underline.

14. The information processing apparatus according to claim 1, wherein the circuitry is configured to
compare the first image data and the second image data to determine whether the first image data and the second image data are based on documents having a same format, and
extract the candidate areas when a result of the comparison indicates that the first image data and the second image data have the same format.

15. An information processing method, comprising:
extracting one or more candidate areas to be digitized, based on a difference between first image data generated based on an unwritten document and second image data generated based on a written document;
executing a character recognition process or a shape recognition process on the second image data to obtain a recognition result; and
setting one or more areas to be digitized based on the candidate areas to be digitized and the recognition result.

16. A computer-readable, non-transitory medium storing a computer program, which causes one or more computers to perform an information processing method comprising:
extracting one or more candidate areas to be digitized, based on a difference between first image data generated based on an unwritten document and second image data generated based on a written document;
executing a character recognition process or a shape recognition process on the second image data to obtain a recognition result; and
setting one or more areas to be digitized based on the candidate areas to be digitized and the recognition result.
